(19) United States
(12) Patent Application Publication
(10) Pub. No.: US 2016/0171453 A1
(43) Pub. Date: Jun. 16, 2016

(54) SOCIAL MEDIA SYSTEM AND METHOD FOR SPORTS

(71) Applicant: Jesse L. Zorfas, Newton, MA (US)

(72) Inventor: Jesse L. Zorfas, Newton, MA (US)

(21) Appl. No.: 14/966,798

(22) Filed: Dec. 11, 2015

Related U.S. Application Data
(60) Provisional application No. 62/090,702, filed on Dec. 11, 2014.

(51) Int. Cl. G06Q 10/10; G06Q 50/00

(52) U.S. Cl. CPC G06Q 10/1095; G06Q 50/01

(57) ABSTRACT

A method, apparatus, or computer program product for scheduling an athletic event between a plurality of users on a social-network-website-service is described. The social network system provides users with a graphical user interface comprising an interactive calendar, a communication window, and a user-customized browser tool. The social network system receives a user-created base profile, which comprises information about a user and a plurality of individual sport profiles. Each individual sport profile comprises a set of criteria. The social network system receives event parameters which enable scheduling of the identified sport between at least two of the plurality of users.

### RELATED APPLICATION

This application claims the benefit of U.S. Provisional Application No. 62/090,702, filed on Dec. 11, 2014. The entire teachings of the above application are incorporated herein by reference.

### BACKGROUND OF THE INVENTION

People routinely rely on social networking and social media websites and mobile phone applications (“apps”) to meet new people and to arrange meetings in-person. Current websites and apps facilitate meeting new people and providing means for arranging meetings between two or more users. These websites also allow users who share mutual interests to connect, exchange messages, and then meet in person. The most prominent example of this is a dating website or app, in which members can search for other users based on specific criteria, and selectively message and schedule a meeting with said user.

Most of these social networking websites and apps are matchmaking systems which facilitate the meeting of unmarried or unattached individuals for the purpose of dating. It is significantly more difficult, however, for a person to find others to socially interact with for purposes other than dating. For example, few websites and apps facilitate meetings between unacquainted individuals for the purposes of playing a game of golf or tennis. Even social networks that allow users to meet for these purposes rely on a basic messaging system for users to interact and schedule when they are available to play a desired game. Moreover, specific users looking to find others to play golf or tennis may want to play with others who have a specific amount of skill or experience, or others who have a more competitive versus relaxed attitude when playing a sport. Additionally, businesses and groups seeking new players of a specific skill set may require pervasive direct-messaging of users to assess whether a potential player has the desired level of skill or experience to participate according to the business's or group's needs.

Thus, a need exists for a system capable of effectively permitting social networking for people by facilitating identification of others who desire to offer and accept participation in sporting events using computer networking.

### SUMMARY OF THE INVENTION

The present invention provides a solution for users looking to meet new people and schedule activities related sports with ease, as well as find other users who share similar experiences and interests with respect to participating in sporting events. Embodiments of the present invention system include an apparatus and method enabling a user to search for and connect with other users based on those users' individual preferences for playing one or more sports. Embodiments also enable a user to determine an optimal sports partner or sports group among a plurality of existing users, and groups of users, based on a variety of associated criteria. For example, skill level, ideal or available playing time, location, or keywords may all be provided by a user to filter through lists of users, events, or groups. Embodiments enable users to create personal profiles with preferred criteria for finding optimal partners for participating in a sport together. Some embodiments may enable users whom are members of existing sports groups or associations to create corresponding groups or subgroups in order to interact with existing users, invite new users to the group, schedule events, or find new partners in any existing group. Accordingly, embodiments enable leaders of groups to organize their existing members and events, communicate with their members, invite new members, and set up new events.

Embodiments also enable groups to attract new members by enabling users to find compatible groups by searching and filtering existing groups using criteria provided by each user. Additionally, embodiments may provide consistent color coding of selected user criteria displayed across visual depictions of users, events, and groups to improve the user's ability to quickly visually search those elements in a web page environment. For example, a user may have a preference for a particular sport and a particular skill level, both of which would receive corresponding color codes, and one or both of those color codes may be shown on another user's profile (if that user shares the corresponding preference) or shown on an event (if the invent involves that sport or skill level).

Accordingly, in an example embodiment, the present invention is a method, a computer-implemented method, apparatus, or computer program product for scheduling an athletic event between a plurality of users on a social-network-website-service, the method, computer-implemented method, apparatus, or computer program product comprise providing to a user, by a social network system, a graphical user interface, said graphical user interface comprising an interactive calendar, a communication window, and a user-customized browser tool; receiving, by a social network system, a user-created base profile, wherein the user-created base profile comprises information about a user and a plurality of information sport profiles, each individual sport profile comprising a set of criteria. The set of criteria is related to an identified sport on one of the plurality of individual sport profiles and comprises parameters relating to said user's preferences with respect to the identified sport. The method, computer-implemented method, apparatus, or computer program product further comprise receiving, by the social network system, event parameters which enable scheduling of the identified sport between at least two of the plurality of users, the scheduling of the identified sport includes arranging an appointment between the at least two plurality of users. Event parameters include a common identified sport selected by the at least two of the plurality of users, and a venue. Arranging the appointment between at least two of the plurality of users includes indicating availability for each user to participate in the common identified sport selected by the at least two of the plurality of users via the interactive calendar. The method, computer-implemented method, apparatus, or computer program product further comprise arranging, by the social network system, the athletic event between the plurality of users, wherein arranging includes communicating to the plurality of users the common identified sport availability of each user.

In another embodiment, the athletic event is selected from the group consisting of: golf, basketball, baseball, soccer, tennis, cycling, running, hockey, skiing, snowboarding, softball, sledding, rock climbing, volleyball, football, lacrosse, rowing, squash, racquetball, surfing, sailing, kayaking, dirt biking, martial arts, boxing, snowmobiling, snowshoeing, hunting, fishing, wrestling, and weight lifting.

In another embodiment, the user is a single person.

In another embodiment, the user is a group of people.

In another embodiment, the user is a business organization.

In another embodiment, the method, computer-implemented method, apparatus, and computer product further comprise the step of receiving, by the social network system, advertisements from the business organization.

In another embodiment, the business organization is selected from the group consisting of: sports clubs, golf clubs, tennis clubs, and gyms.

In another embodiment, the business organization is a sports club, and the method, computer-implemented method, apparatus, and computer program product further comprise the steps of: identifying, by the social network system, a plurality of club members from the plurality of users on the social-network-website-service; and aggregating, by the social network system, the set of criteria from each individual sport profile of the plurality of club members to create a set of club member data.

In another embodiment, the business organization provides each of the plurality of club members with a feedback form.

In another embodiment, the feedback form requests information from each of the plurality of club members regarding facilities provided by the business organization.

In another embodiment, the facilities are selected from the group consisting of: caddy access, pool conditions, basketball court conditions, golf course conditions, racquetball court conditions, and locker room conditions.

In another embodiment, the method, computer-implemented method, apparatus, and computer program product further comprise the steps of analyzing, by the social network system, the set of club member data.

In another embodiment, the step of analyzing the set of club member data includes: identifying a peak use time for the sports club, identifying attendance habits of the plurality of club members.

In another embodiment, the method, computer-implemented method, apparatus, and computer program product further storing in a database consumer purchase data from each of the plurality of club members.

In another embodiment, the consumer purchase data comprises makes and models of inventory sold.

In another embodiment, the method, computer-implemented method, apparatus, and computer program product further comprise identifying, by a social network system, a plurality of employees from the plurality of users on the social-network-website-service; providing, by a social network system, an employee communication window, wherein the employee communication window is accessible to the plurality of employees identified by the social network system; and providing an interactive employee calendar, wherein the interactive employee calendar enables scheduling of an employee work shift for each of the plurality of employees and the business organization.

In another embodiment, the criteria is a user-specified ranking of skill in a sport.

In another embodiment, the criteria includes at least one of the following: interests, geographical location, willingness to travel, favorite venues, age, gender, relationship status, religious background, smoking habits, drinking habits, occupation, sport accomplishments, ideal conversation topics, intensity, competitiveness, pace of play, leadership, demeanor, betting, position, strengths, and weaknesses.

In another embodiment, the method, computer-implemented method, apparatus, and computer program product further comprise receiving, by the social network system, instructions from a user to search for other users using a user-defined set of criteria, and providing to the user a list of other users which match the user-defined set of criteria.

In another embodiment, the method, computer-implemented method, apparatus, and computer program product further comprise receiving, by the social network system, a request for a list of users that match with the user-defined set of criteria.

In another embodiment, the method, computer-implemented method, apparatus, and computer program product further comprise receiving, by the social network system, a request by a first user to send a message to a second user and to send and display said message to said second user.

In another embodiment, the calendar indicating sport-specific availability is organized by color, wherein one color correlates to one sport.

In another embodiment, the method, computer-implemented method, apparatus, and computer program product further comprise receiving, by the social network system, information from one of the plurality of users regarding a rating of another user.

In another embodiment, the method, computer-implemented method, apparatus, and computer program product further comprise receiving, by the social network system, information indicating that a first user has selected another user as a favorite.

In another embodiment, arranging, by the social network system, the athletic event further comprises making a reservation at a selected venue.

In another embodiment, the social-network-website-service is a mobile phone application.

In another embodiment, the user-customized browser tool appears consistently on substantially all base profiles and sport profiles that the user views.

In another embodiment, the communication window and the interactive calendar for the user appear consistently on substantially all base profiles and sport profiles that the user views.

In another embodiment, the communication window receives and sends messages from one or more of the plurality of users.

In another embodiment, the communication window is organized by message color, said message color selected by the user.

In another embodiment, the message color selected by the user indicates a sport.

In another embodiment, the message color selected by the user indicates another user.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of an example graphical user interface of an individual user's base profile, viewed from the perspective of the user.

FIG. 2 is an illustration of an example graphical user interface of a user's individual sport profile.

FIG. 3 is an illustration of an example graphical user interface of a browser tool.

FIG. 4 is an illustration of an example graphical user interface of a group's base profile.

FIG. 5 is an illustration of an example graphical user interface of a business's biography page as viewed by other users.

FIG. 6 is an illustration of an example graphical user interface of a business's base profile.

FIG. 7 is an illustration of an example graphical user interface of a business's member management page.

FIGS. 8a-b are example feedback forms that can be filled out by one of the plurality of users for feedback for a business organization or sports club.

FIG. 9 is an overview of a communications pathway for sending and receiving profile, scheduling, and message data between a plurality of users and the social network system.

FIG. 10 illustrates a computer network or similar digital processing environment in which the present invention may be implemented.

FIG. 11 is a diagram of the internal structure of a computer (e.g., client processor/device 50 or server computers 60) in the computer system of FIG. 10.

FIG. 12 is an illustration of an example graphical user interface of an individual user's home page, viewed from the perspective of the user.

FIG. 13 is an illustration of an example graphical user interface of a user's events page, viewed from the perspective of the user.

FIG. 14 is an illustration of an example graphical user interface of a user's groups page, viewed from the perspective of the user.

FIG. 15 is an illustration of an example graphical user interface of a user's find players page, viewed from the perspective of the user.

FIG. 16 is an illustration of an example graphical user interface of a user's calendar, viewed from the perspective of the user.

### DETAILED DESCRIPTION OF THE INVENTION

A description of example embodiments of the invention follows.

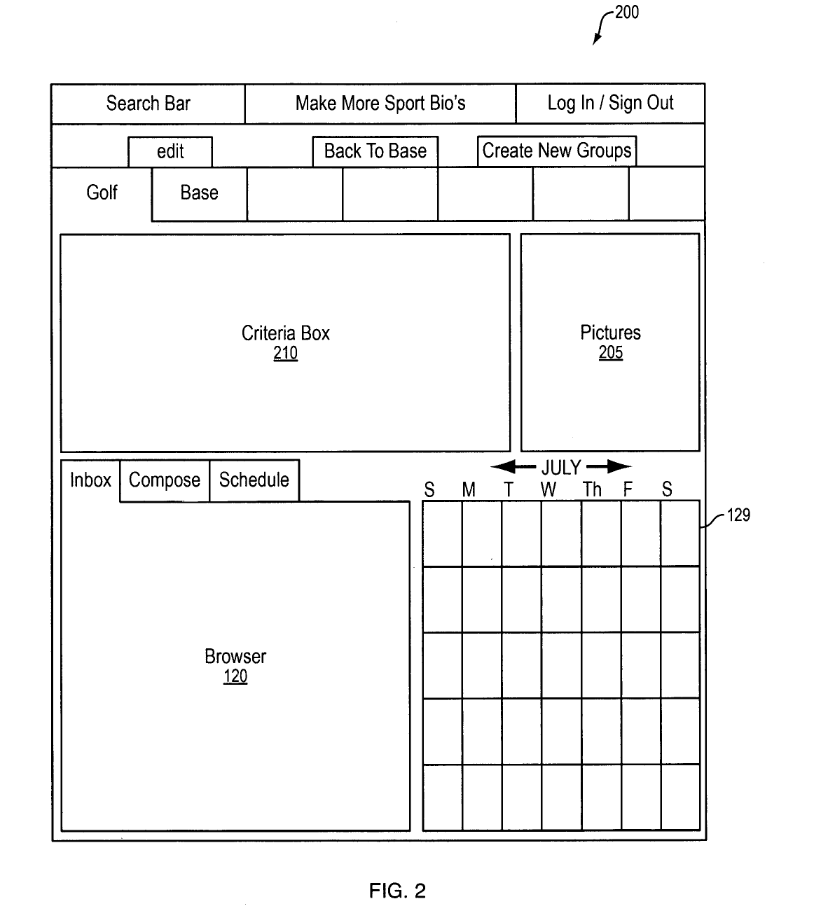

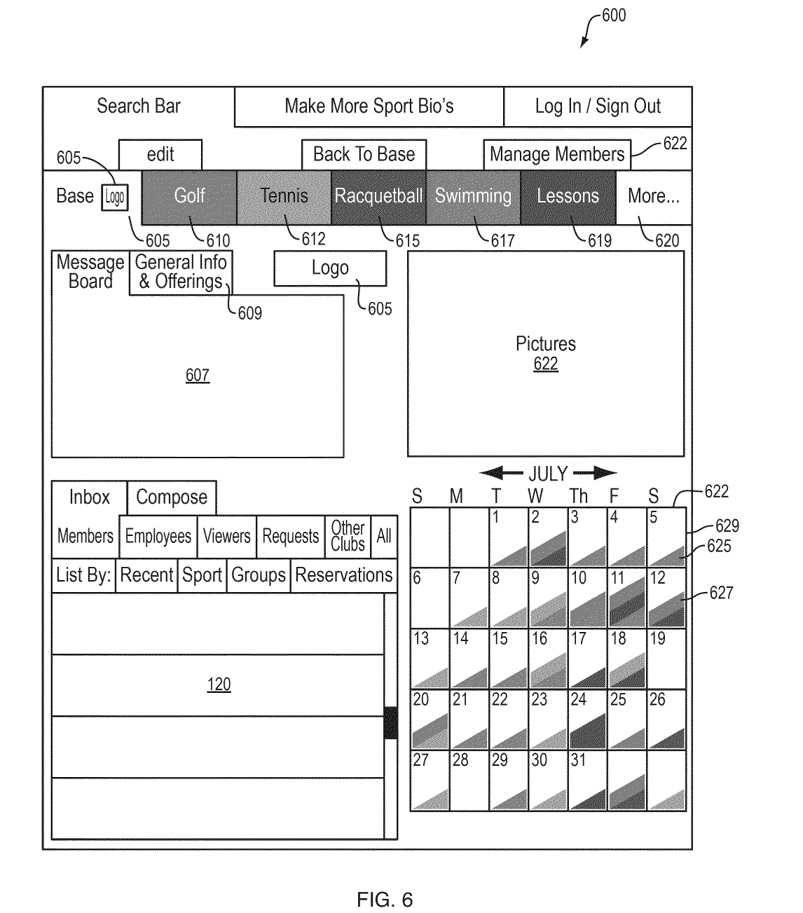

The present invention is drawn to a method, apparatus, or computer program product to facilitate scheduling athletic events between a plurality of users on a social-network-service. The social network service, via a social network system, can provide to a user a graphical user interface, which is described in example embodiments illustrated in FIGS. 2-7 below. The information that a user inputs into the graphical user interface can be received by the social network system. The information can include event parameters which enable scheduling of an identified sports between two or more users.

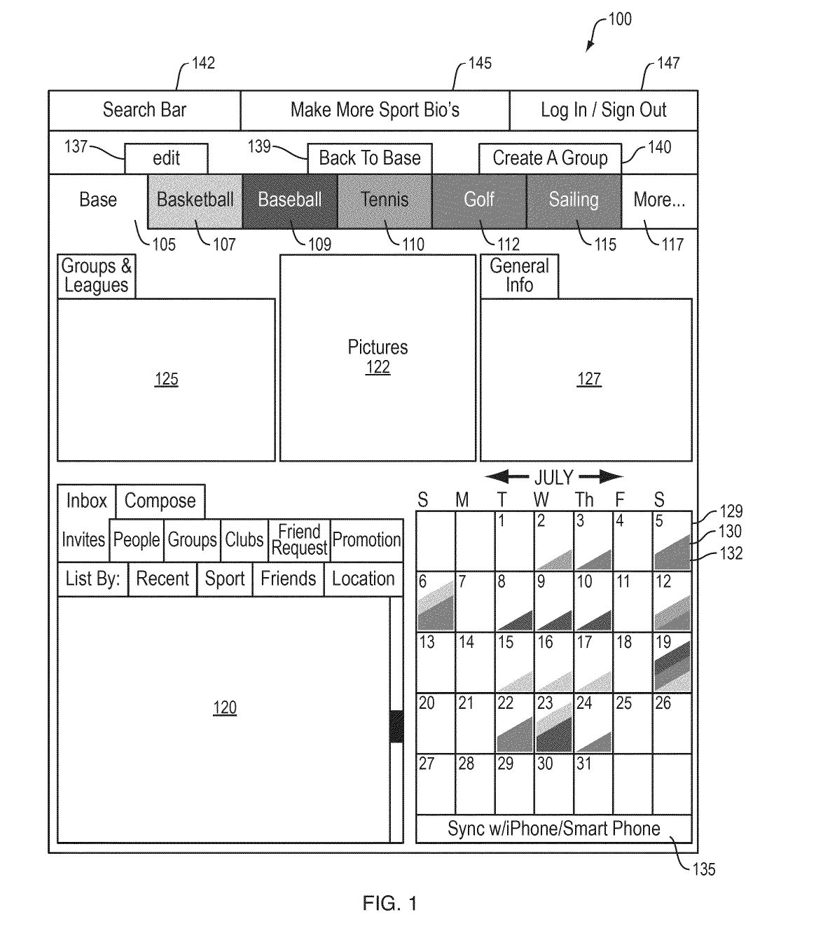

FIG. 1 is an illustration of an example graphical user interface of an individual user's base profile 100, viewed from the perspective of the user. In an example embodiment, a user is a single person. The base profile 100, selected from the tab labeled “base” 105, is the central hub where information about the user is viewed. From the base profile 100, the user can view different groups and leagues 125 that the user belongs to, different pictures 122 that the user has uploaded or otherwise submitted, and view general information 127 that the user has posted about him or herself. The general information 127 can include, for example, location of the user, achievements that the user has accomplished in various different sports, an “about me” profile or other general information that the user wishes other users to view.

The tabs in the example illustration of FIG. 1 include the base 105, basketball 107, baseball 109, tennis 110, golf 112, and sailing 115 are sports that the user has selected. Any number of sports can be included as an individual tab including, for example: golf, basketball, baseball, soccer, tennis, cycling, running, hockey, skiing, snowboarding, softball, sledding, rock climbing, volleyball, football, lacrosse, rowing, snowmobiling, snowshoeing, hunting, fishing, wrestling, and weight lifting. Each tab 105-115 can link to a different individual sport profile, described in FIG. 2, below. The user can create more individual sport profiles by clicking the “make more sport bios” button 145.

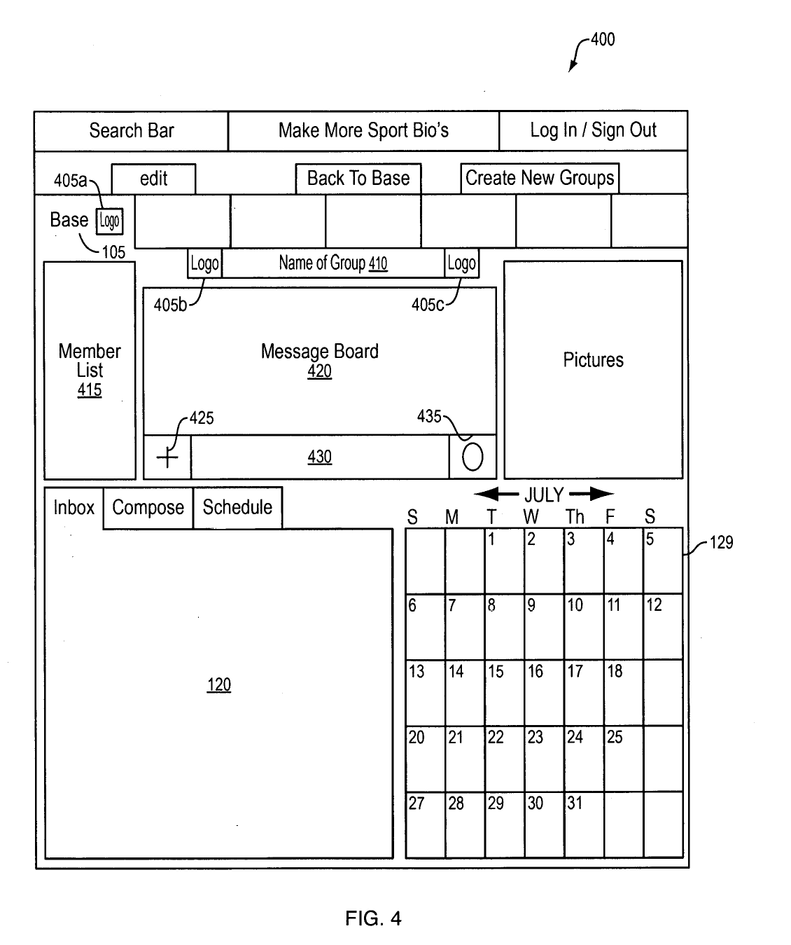

The user can edit their base profiles or any one of their individual sport profiles via the edit 137 button, may return to the base profile from any page that the user views using the “back to base” button 139, or the user may create a group via the “create a group” button 140. Groups are described with respect to FIG. 4, below.

The base profile 100 also includes a “search bar” 142, where users may search for other users based on the criteria that a user has listed both in their individual sport profiles 105-115 as well as their base profile 100. When a user uses the search bar 142, the user can identify a set of criteria that the user would like to see in other users. Thus, in an example embodiment, the social network system can receive, from a user, a user-defined set of criteria, and using the user-defined set of criteria, can provide to the user a list of other users who match the user-fined set of criteria.

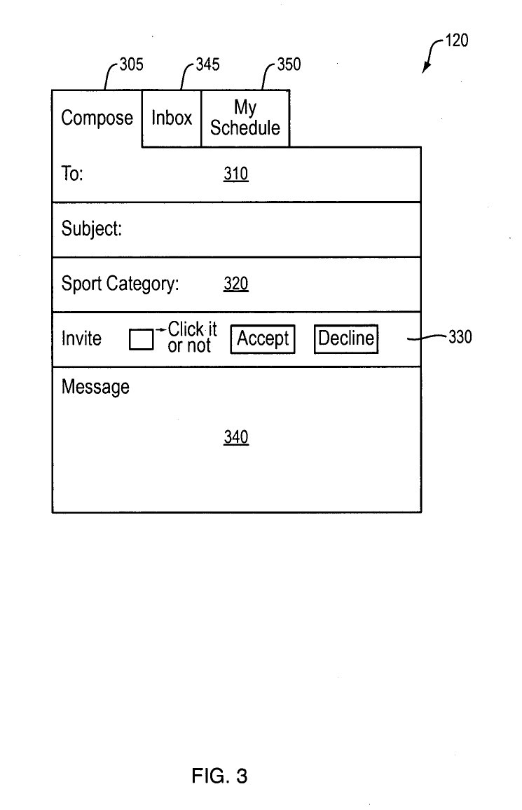

The browser tool 120, as well as the interactive calendar 129 are present on substantially all profiles that a user views, including the user's own base profile 100. The browser tool 120 is described with more detail with respect to FIG. 3, below. The interactive calendar 129 allows a user to indicate their availability to play a sport on any given day. While the browser tool 120 is the same and unique to the user logged into the system, the interactive calendar 129 is unique to the user whose page is being viewed at the time. Therefore, for example, if a first user is viewing a second user's page, the browser tool 120 would be unique to the first user, and contain the information related to the first user's browsing and scheduling of specific sports. The interactive calendar 129 is unique to the second user, where the information that populates the interactive calendar allows the first user to view the second user's identified availability.

A user can also use different colors to indicate which sports they are available to play on specific days. In the example embodiment of FIG. 1, the blue mark 130 corresponds to the blue tab for sailing 115 on the user's base profile. Therefore, the user has indicated that he or she is available to go sailing on July 5. Similarly, the green mark 132 corresponds to the green golf tab 112 on the user's base profile. Therefore, the user has indicated that he or she is available to play golf on July 5. The colors can be set by the user to any color scheme that the user desires. The color correspondence in FIG. 1 is meant to be by way of example only. The user can also connect to a mobile device or other calendar system, such as, for example the user's mobile phone or Outlook calendar. By pressing the “sync” button 135 the user can send the information from the interactive calendar 129 to another calendar that the user desires. When the user is finished with his or her session they can “sign out” via the “log in/sign out” button 147.

The interactive calendar 129 is unique according to each page that the user views. When the user is viewing his or her own profiles, the interactive calendar 129 display information related to the profile being viewed. For example, if the user is viewing his or her base profile 100, the interactive calendar 129 can display all sport availability, coded by color. When the user views a specific sport profile, the interactive calendar 129 can display the specific sport availability of the user, or it can display all availability, if the user desires. When the user is viewing another user's profile, the interactive calendar 129 displays information related to the other user's availability. If the user views a specific sport profile for the other user, the interactive calendar 129 can display availability related to that specific sport for the other user. When a user selects a date and/or time in the interactive calendar 129 that is available, the social network system can automatically schedule the user and the other user to play a specified sport together. In an example embodiment, when the user selects an available time in the interactive calendar 129, the social network system can also reserve a venue for the user and the other user to participate in the specific sport. Example venues include gyms, basketball courts, golf courses, baseball fields, squash courts, racquetball courts, and the like.

FIG. 2 is an illustration of an example graphical user interface of a user's individual sport profile 200. Similar to the base profile 100 of FIG. 1, the individual sport profile 200 contains a criteria box 210, where the user can indicate “criteria” with respect to the individual sport that the user has identified. The user can also indicate what criteria the user is searching for in other member users. Criteria can be any identifying information with respect to a sport and in meeting other users who also play a specific sport. The criteria can be a user-specific ranking of skill or a sport, such as, for example “state champion,” or “elite level.” Example criteria can also include interests, geographical location, willingness to travel, favorite venues, age, gender, relationship status, religious background, smoking habits, drinking habits, occupation, sports accomplishments, ideal conversation topics, intensity, competitiveness, pace of play, leadership, demeanor, betting, position, strengths, and weaknesses. The user can upload pictures 205 that he or she wishes other users to view with respect to that individual sport profile. The browser tool 120, is substantially the same on the individual sport profile 200 as they are on the base profile page 100.

FIG. 3 is an illustration of an example graphical user interface of a browser tool 120. The browser tool 120 can be used to exchange messages between users. Under the compose tab 305, the user can draft a message to a different user 310. The user can select a sport category 320 which allows both the sending and the receiving user to organize the message once it is sent. The buttons labeled “Invite,” “Accept” and “Decline” in box 330 can be used when organizing events between two users. For example, the sending user can send a message to the receiving user in the browser tool 120, and can select “Invite” to invite the receiving user to play a sport selected in sport category box 320. The receiving user will see buttons labeled “Accept” or “Decline” in box 330 when they receive the message. Box 340 is available for the sending user to draft a message to the receiving user.

The social network system can also have a rating system and allow users to select “favorite” users. A favorite user can be listed separately from other contacts or compiled in a list stored by the social network system. The user can use a color to identify others that the user has selected as a favorite.

The browser tool, under the Inbox tab 345, allows a user to view the messages he or she has received. The user can organize the messages in the Inbox tab 345 according to sport, user, date, or other means. The user can use a color to correlate to a specific sport. For example, referring to the color coordination of FIG. 1, blue was used to represent sailing. If a sending user, for example, selects sailing as the sport category 320, the message will arrive in the receiving user's Inbox 345 labeled with a blue color. The color coordination can be selected by the user. Accordingly, in an example embodiment, the social network system can receive a request by a first user to send a message to a second user and to send and display said message to said second user.

The browser tool, under the tab labeled “My Schedule” 350 allows the user to identify their availability with respect to certain sports on certain days. When the user selects the “My Schedule” tab 350, the placement of the browser tool 120, being next to the interactive calendar 129, allows the user to easily identify common times and availability to set up a meeting between the users to play a sport.

Accordingly, in an example embodiment, the present invention is a method, apparatus, or computer program product for scheduling an athletic event between a plurality of users on a social-network-website-service, the method, apparatus, or computer program product comprising providing to a user, by a social network system, a graphical user interface, said graphical user interface comprising an interactive calendar, a communication window, and a user-customized browser tool. The social network system can then receive a user-created base profile, wherein the user-created base profile comprises information about a user and a plurality of individual sport profiles, each individual sport profile comprising a set of criteria, wherein the set of criteria is related to an identified sport on one of the plurality of individual sport profiles and comprises parameters relating to said user's skill level with respect to the identified sport. The social network system can receive event parameters which enable scheduling of the identified sport between at least two of the plurality of users, the scheduling of the identified sport includes arranging an appointment between the at least two of the plurality of users, wherein event parameters include a common identified sport selected by the at least two of the plurality of users, and a venue, and wherein arranging the appointment between at least two of the plurality of users includes indicating availability for each user to participate in the common identified sport selected by the at least two of the plurality of users via the interactive calendar. The social network system can then arrange the athletic event between the plurality of users, wherein arranging includes communicating to the plurality of users the common identified sport availability of each user.

In another example embodiment, the user is a group of people. FIG. 4 is an illustration of an example graphical user interface of a group's base profile 400. A group, as used herein, refers to a collection of users who are part of an informal or formal team or association that is organized to play a sport together. In an example embodiment, a group can be a sports team, such as a baseball team. In another example, a group can be a collection of 6 users who play 3 vs. 3 basketball. The group's base profile 400, selected by pressing the “base” tab 105, can display different information than the individual profiles in FIGS. 1 and 2. The group base profile 400 can be managed by an administrator or manager of the group. The group base profile can also display the name of the group 410 in a title spot on the group's base profile 400. In the example group base profile 400 of FIG. 4, the administrator can choose a logo 405a-c and place the logo 405a-c in various spots on the group base profile 400 page. The group base profile can have a member list 415 where users viewing the page can see a list of members that belong to the group. The member list 415 can be set to a private mode where it is only viewable by members of the group.

The group base profile 400 can also have a message board 420, where members of the group can communicate to one another via a public forum. The message board 420 can be publicly viewed, or set to private so that only members of the group can view the contents of the message board 420. The message board 420 can provide a section where members can input text 430, or an option where users can upload pictures or video 425. In an example embodiment, a group can be dedicated to multiple sports. For example, a group can be for users who play basketball in the winter, and baseball in the spring. Accordingly, in an example embodiment, a user or member viewing the message board can organize the messages according to sport. A user or member can use an example button 435 to assign a sport to a color. The user or member can assign the color to coincide with the color coordinate from the user's individual sport profile. For example, referring to the base profile of FIG. 1, basketball 107 coincided with the color yellow. The user or member viewing the message board 420 of the group page can have all messages related to basketball marked as yellow, if desired. The browser tool 120 remains substantially the same as on the individual user's base profile 100, whereas the interactive calendar 129 can correspond to the group's indicated availability.

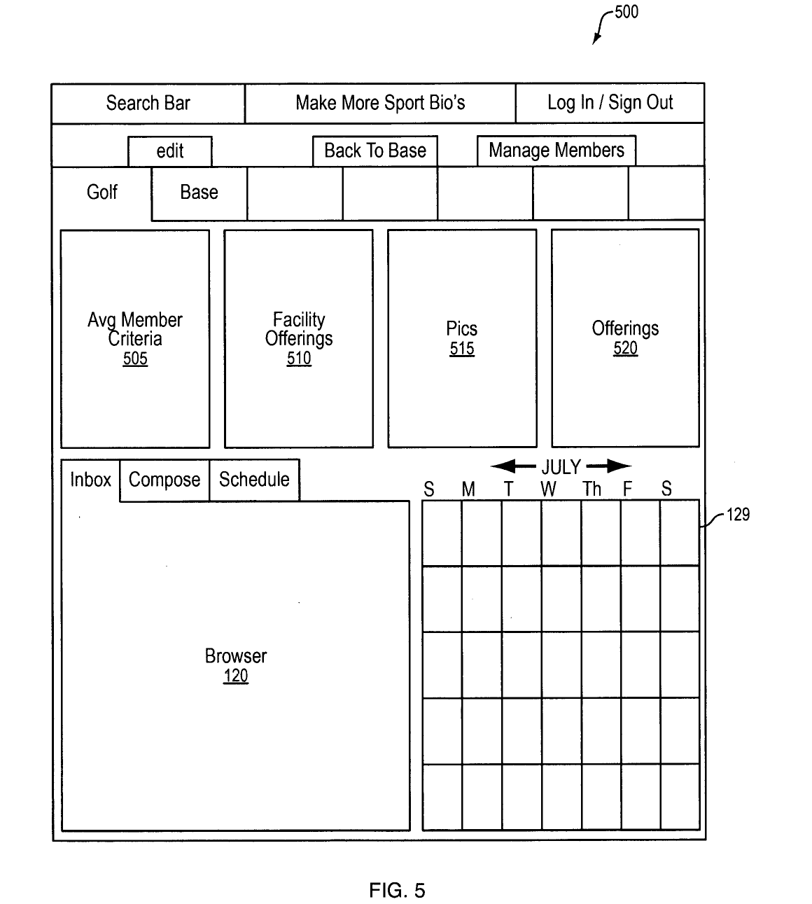

FIG. 5 is an illustration of an example graphical user interface of a business's biography page 500 as viewed by other users. A business, as described herein, can be any organization that generates a commercial profit. Examples of businesses include golf clubs, gyms, racket clubs, tennis clubs, rental companies (e.g., ski rental, boat rental, skate rental, etc.), ice rinks, pool facilities, college or university facilities, field managers (e.g., parks), teaching professionals, leagues and the like. The business biography page can have a base page or an individual page dedicated to any sport that the business chooses. For example, a gym can have a page dedicated solely to racquetball, and a page dedicated solely to swimming, all accessible from the business's base page. In the example business biography page 500, the user is viewing the business's golf page. The business can indicate the average member criteria 505 that the business desires a user or member to have prior to joining the business organization. For example, the business can state that it is only seeking new golf members who are capable of playing below a certain handicap. Alternatively, the business can state that only members who are proficient swimmers can join the business's pool.

The business can illustrate its facility offerings 510, by way of a list or pictures or both. Similarly, the business can post pictures 515 and illustrate other offerings 520 that the business has available for members. Offerings can be, for example, a racquetball court, a squash court, a basketball court, a golf course, a pool, a weightlifting room, exercise equipment such as treadmills or stationary bicycles, a bicycle fitting expert, a gait analysis coach, a swim instructor, a store to sell equipment to members, and the like. The browser tool 120 is substantially the same as it appears on the individual user's base profile 100 as illustrated in FIG. 1.

The interactive calendar 129 can indicate the business's availability for any of the facilities or services that the business offers. The interactive calendar 129, like the other interactive calendars of both the individual user and the group, can be color-coded or otherwise organized to indicate availability for a specific sport or athletic event. The interactive calendar, when used to organize an athletic event with another user, can reserve a room or court or course at the business's venue.

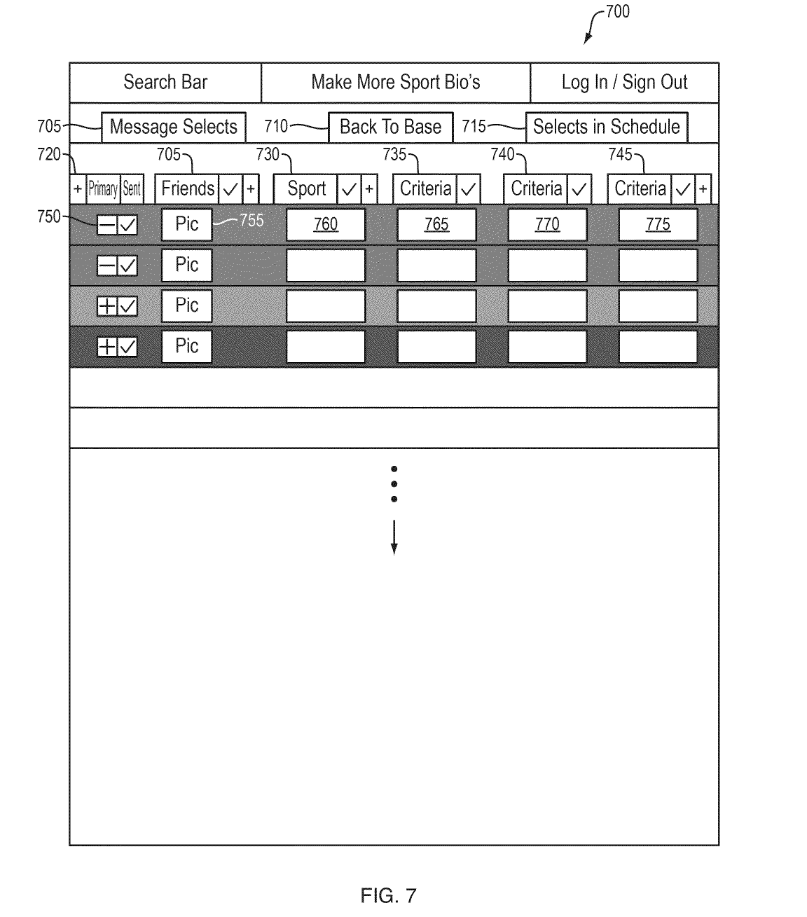

A business can also use its business page to manage members. FIG. 7 is an illustration of an example graphical user interface of a business's member management page 700. Similar pages can exist for groups who wish to organize their members. A business or group can use this page to organize events for certain members. For example, users can be added to an event list by selecting the “add” button 720. The user added can then appear on the list, with an optional picture 755. The business can identify which sport 730 the users will play, which is reflected in the user's selection box 760. The business can also search for criteria 735-745 to facilitate population of the member list. The criteria are then reflected in the user selection box 765-775. For example, if the business is organizing a baseball game, the business will need to fill the various positions on the baseball field. Accordingly, the business can use the criteria search to identify users who play various positions, such as pitcher, catcher, first base, second base, third base, and the like. The business can then use the “selects in schedule” button 715 to see the various schedules of the selected users. The business can also message all the selected users at once by pressing the “message selects” button 705. When the business is done organizing the member or user list, it can return to the base profile page by selecting the “back to base” button 710.

When the method, apparatus, and computer program product described herein are used by a business organization, the business organization can use the data provided by users to create a more interactive membership and to assist with organization of the business organization's day-to-day operations. In an example embodiment described below, the business organization is a sports club, but the business organization can be any organization, including, but not limited to, golf clubs, pool halls, parks, velodromes and the like.

The sports club, via the social network system, can identify a plurality of club members from the plurality of users, which allows the business to directly message or request feedback or votes from club members. Additionally, the business organization can collect and/or aggregate data from the individual sport profiles of each of the plurality of club members. Example data collected and/or aggregated data can include how often a club member visits the club, what days the club member visits the club, what sports the club member plays, what criteria the club member has listed on each of the club member's individual sport profile pages, what purchases the club member has made from the sports club, and the like. With respect to the purchases, the purchase history of each club member can be stored in a database. This information can be analyzed to identify which makes and models of equipment are the most popular as well as act as a basic inventory system to assist the business organization with tracking which items need to be re-stocked. The inventory can be any type of item the business organization sells, such as sporting equipment, clothing, or accessories.

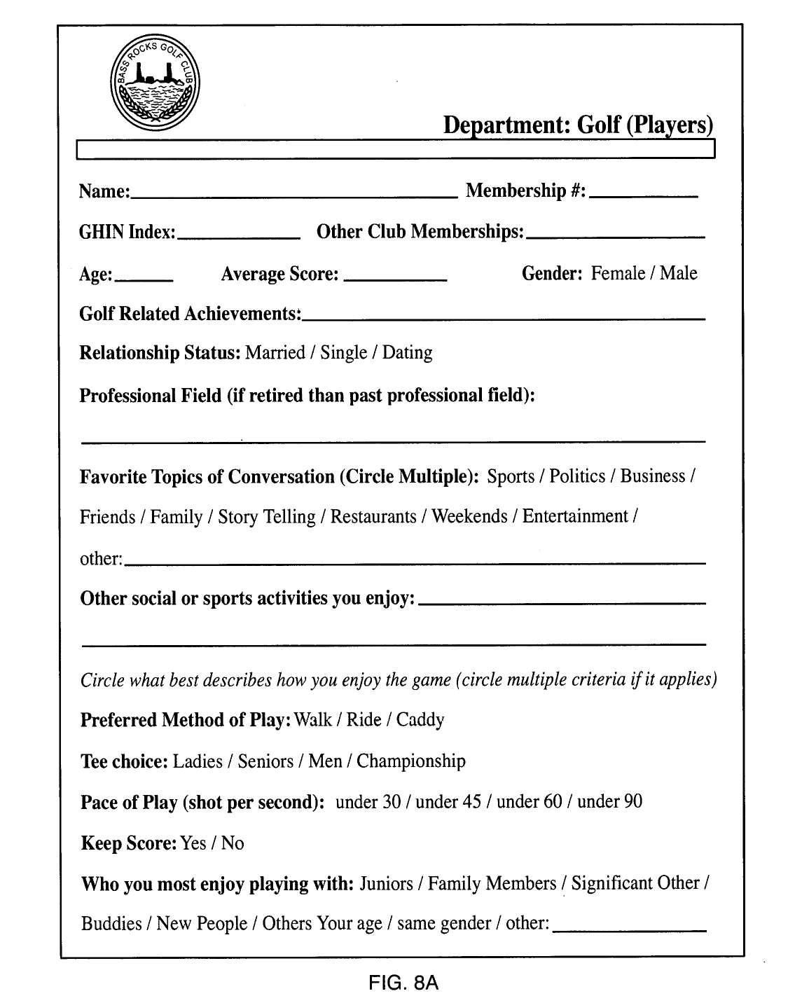

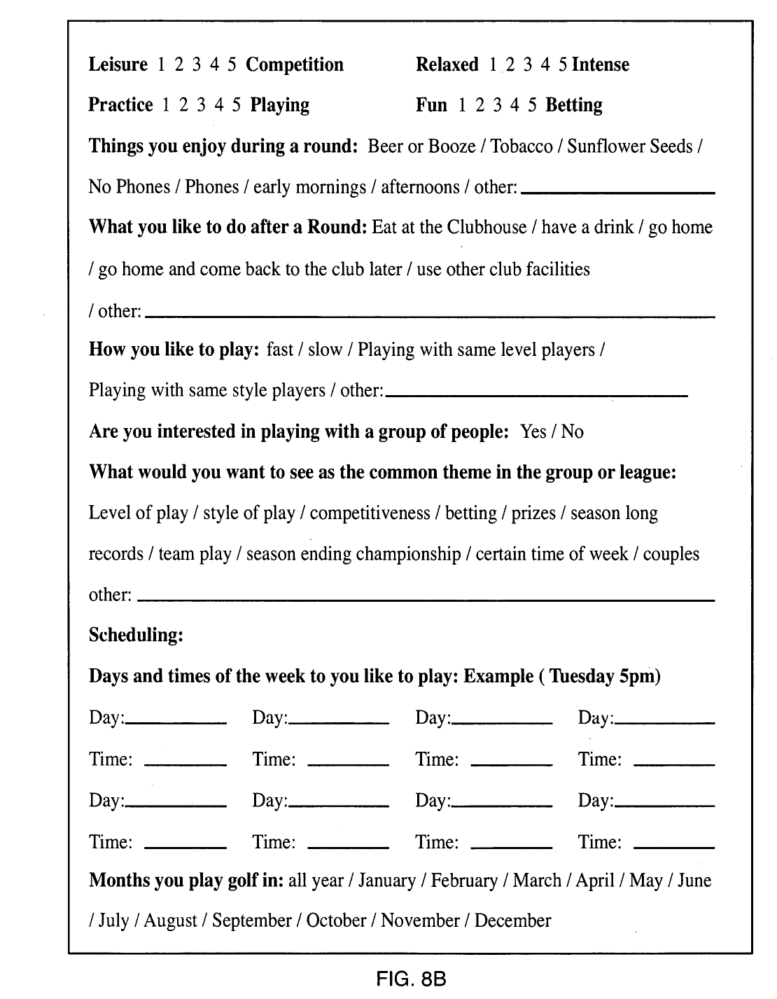

The business organization can analyze this aggregated data via the social network system to identify information such as the level of play, style, competitiveness, and relationship status of the plurality of club members. The business organization can provide feedback forms to solicit information or votes from the plurality of club members. An example feedback form can be seen in FIGS. 8a-b, directed explicitly to club members who participate in golf, although different types of feedback forms can be created. Feedback forms for different sports can also be used such as for golf, basketball, baseball, soccer, tennis, cycling, running, hockey, skiing, snowboarding, softball, sledding, rock climbing, volleyball, football, lacrosse, rowing, snowmobiling, snowshoeing, hunting, fishing, wrestling, and weight lifting. The form can provide the business organization with information that can be aggregated from the plurality of club members, and analyzed to provide metrics about the plurality of club members as a whole. For example, the business organization can determine the percentage of club members that are single, married, or dating. This information is useful for the business organization as it allows the business organization to determine how to best spend funds and to create well-attended events amongst the plurality of club members. Additionally, the business organization can request feedback regarding the facilities on the premises, which can inform the business organization of the needs of the plurality of club members. For example, the plurality of club members can provide feedback regarding caddy access, pool conditions, basketball court conditions, golf course conditions, racquetball conditions, and locker room conditions.

The business organization can, via the social network system, identify club members who frequent the business organization often. The business organization can designate this subset of the plurality of club members with a title or otherwise indicate that this subset of club members can be given specific privileges. Example privileges include preferred play options, gift certificates, club credit, trips, and the like.

The feedback form of FIGS. 8a-b can also be used to solicit votes from the plurality of club members. If, for example, the business organization desires input from the plurality of the club members regarding decisions such as changes to facilities, league development, or remodeling of the facilities, the business organization can use the social network system to request direct input from the plurality of club members.

The business organization can also, via the social network system, allow employees to create a user-profile on the social-network-website-service. The social network system can then identify a plurality of employees from the plurality of users on the social-network-website-service. The employee profiles can have an employee communication window, which is a communication window for use between employees and employers of the business organization. The employee profile page can also have an interactive calendar, analogous to the interactive calendar 129 described above. The interactive calendar can centralize employee scheduling onto the social-network-website-service to facilitate the management of the business organization.

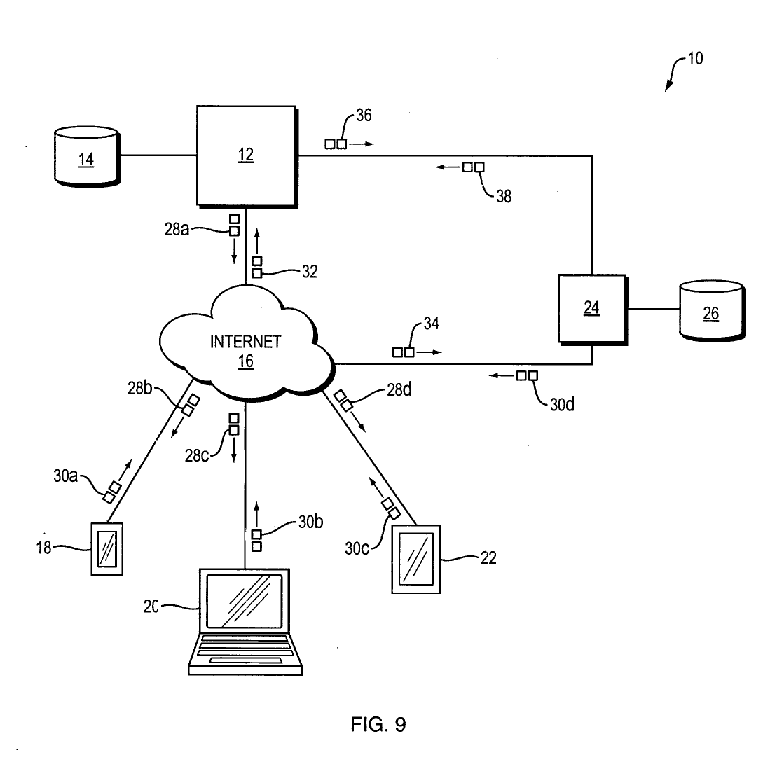

FIG. 9 is an overview 10 of a communications pathway for sending and receiving profile, scheduling, and message data between a plurality of users and the social network system 12. The social network system 12 can connect to the internet 16, and have a database 14 stored locally. A plurality of users using devices such as a mobile phone 18, a personal computer 20, or a tablet device 22 can connect to the social network system 12 via the internet 16. A user can also be a business organization 24 and can connect to the social network system 12 via the internet or directly. The business organization can store data about a plurality of users, the plurality of club members, or other information (e.g., purchase data for the plurality of club members) on a local database 26.

The social network system 12 can provide to the users 18, 20, 22, the graphical user interfaces described in FIGS. 1-7 which the plurality of users can use to create a base profile and the individual sport profiles, as well as other data such as messages and scheduling requests 28a-d. Each user 18, 20, 22 can send user data 30a-d back to the social network system 12 via the internet 16 which the social network system can receive as aggregated data 32.

The business organization 24 can also receive data 34 related to graphical user interfaces for creating a base profile, a calendar, messages, or scheduling requests which might be distinct from the data 30a-c sent to a user 18, 20, 22. The data 34 received by the business organization 24 can also be employee data such as employee schedules or messages from employee, or other data that the business organization 24 can use to schedule employees. The data 34 can ultimately be the same as the data 30a-c, or in other cases, it may be different.

The business organization can also send data 38 about the plurality of club members that interact with the business organization to the social network system 12. This data can be aggregated by the social network system 12, and analyzed data 36 can be sent back to the business organization 24 from the social network system, either directly or via the internet 16. The analyzed data 36 can be, for example, data described above with respect to FIGS. 8a-b, such as identifying club members who frequent a sports club the most often, what are the peak times of use for the business organization, the playing habits of the plurality of club members (e.g., casual or competitive, looking for conversation or looking to keep quiet, drinking or not on the golf course, etc.).

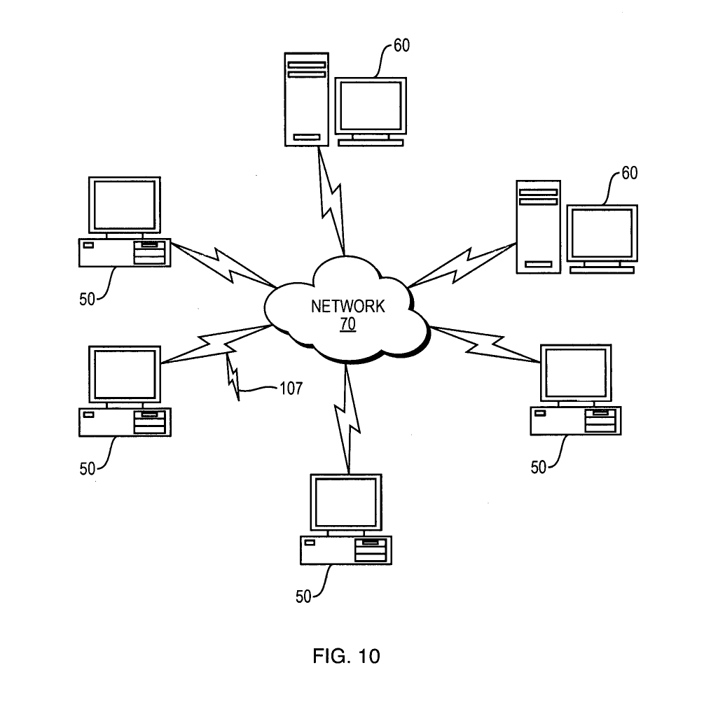

FIG. 10 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

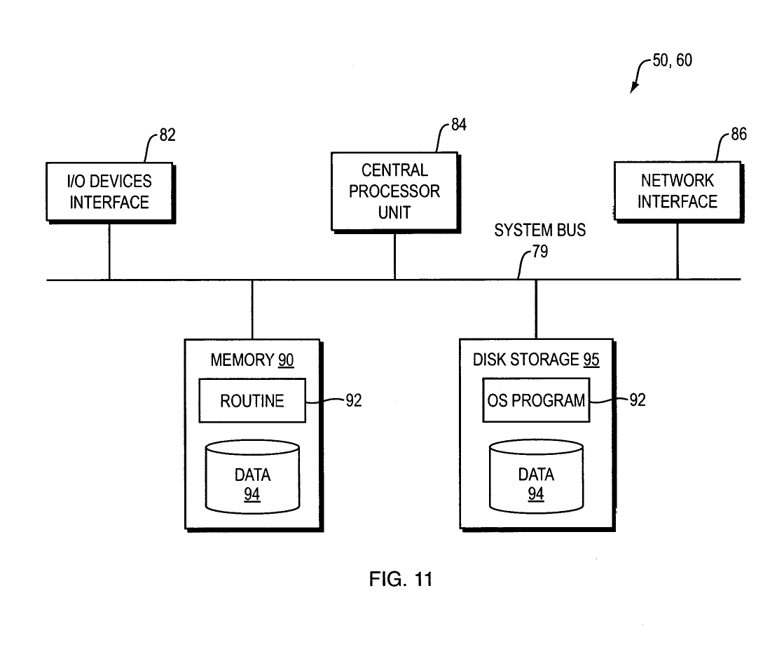

FIG. 11 is a diagram of the internal structure of a computer (e.g., client processor/device 50 or server computers 60) in the computer system of FIG. 10. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 9). Memory 90 provides volatile storage for computer software instructions 92 and data 94 used to implement an embodiment of the present invention. Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

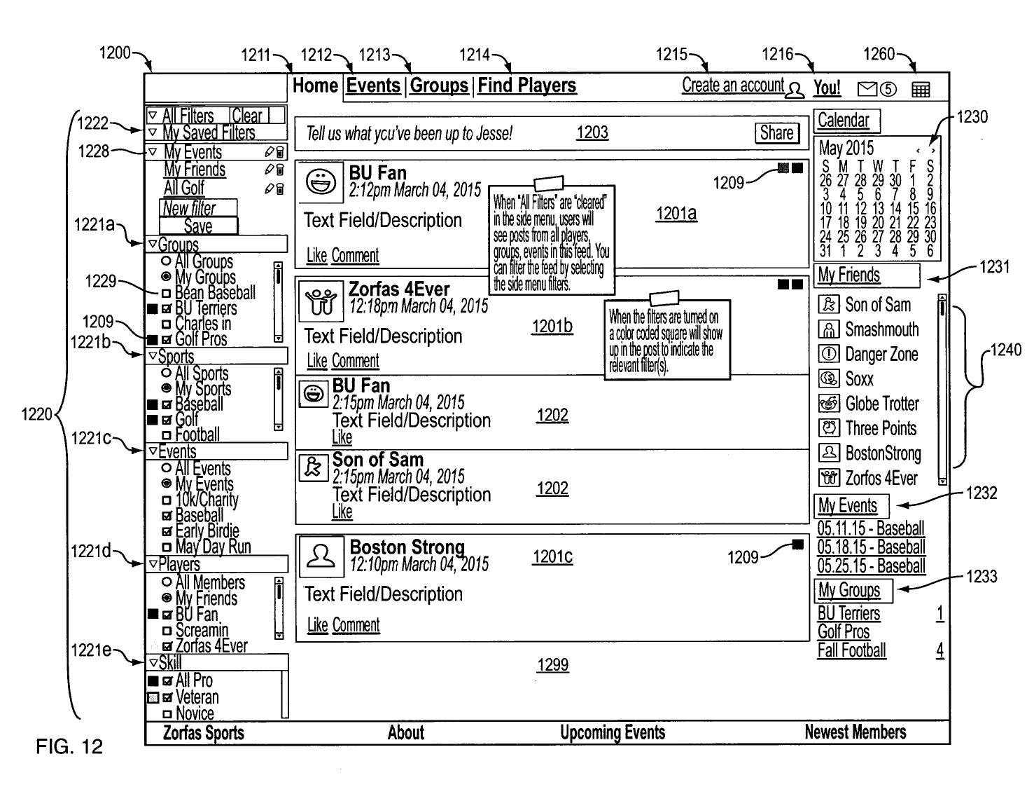

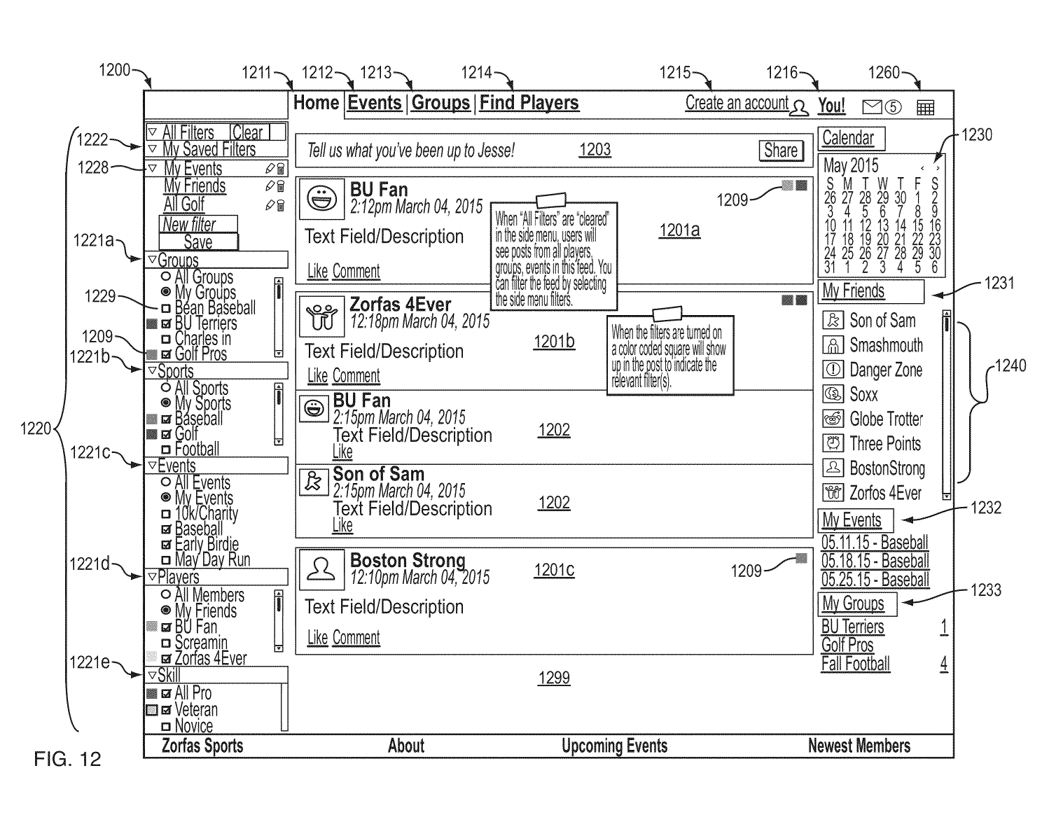

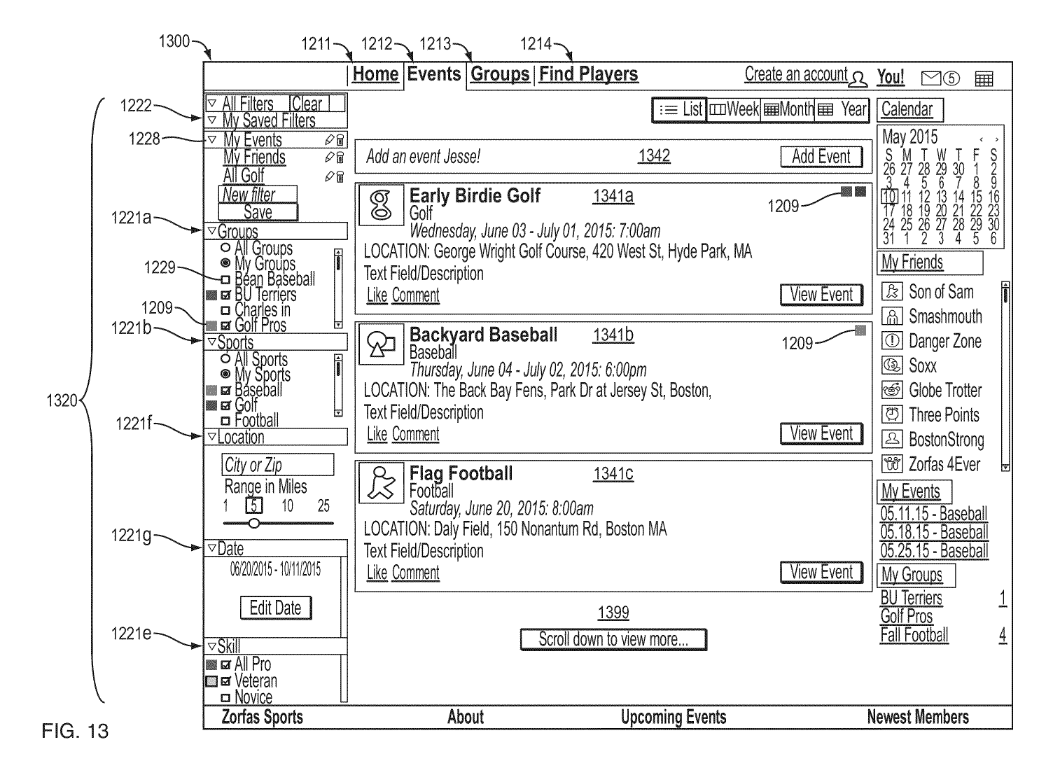

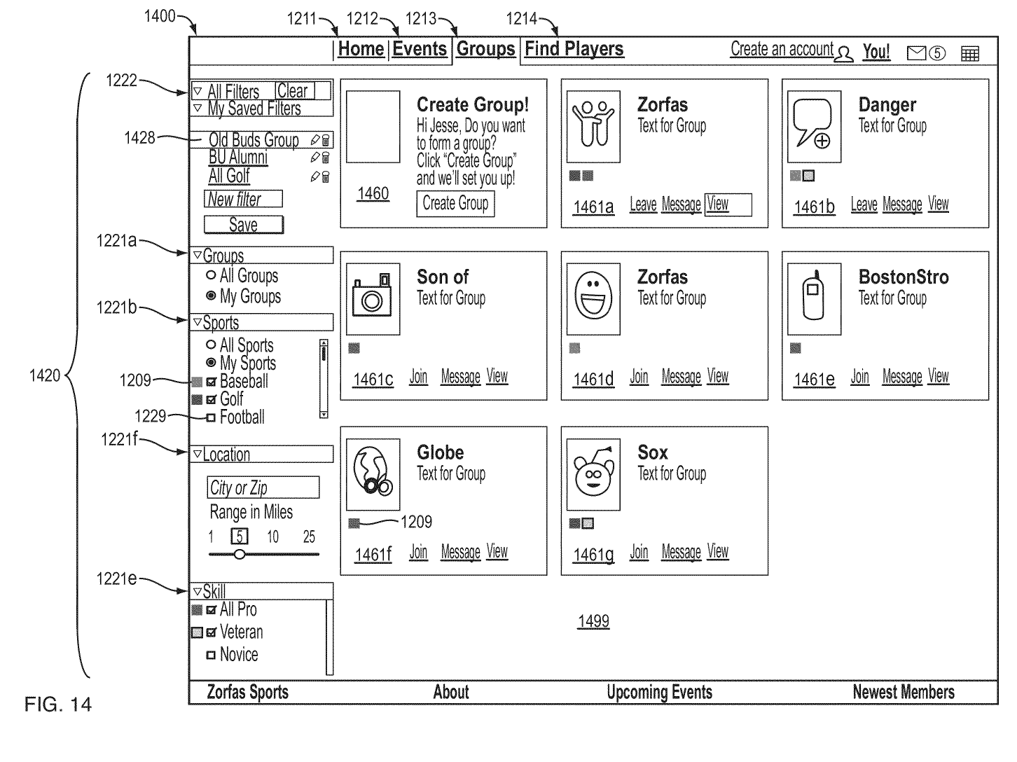

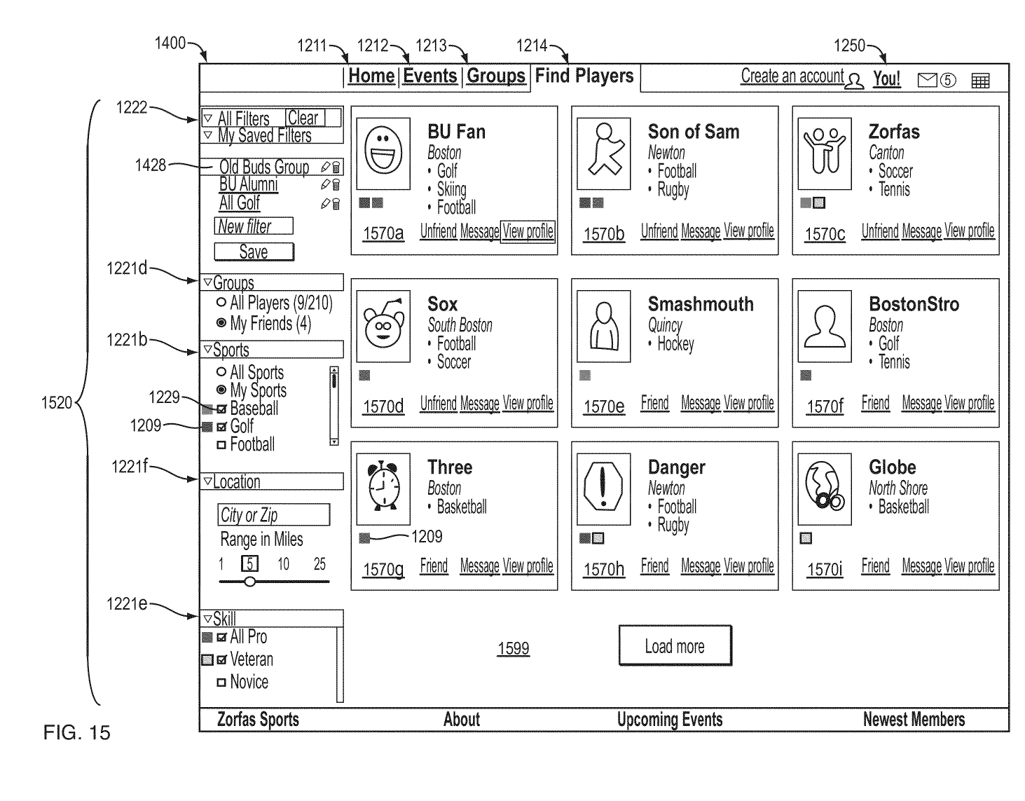

FIG. 12 is an illustration of an example graphical user interface of an individual user's home page, viewed from the perspective of the user. The home page 1200 enables a user to see updates posted by their friends or groups and filter the updates by a variety of parameters 1299. FIG. 12 shows a home page 1200, as indicated by the selection of a home tab 1211, with a plurality of navigation tabs 1211-16, a main window 1299, a filtering interface 1220, a plurality of user notifications 1201a-c in the main window 1299, a calendar 1230, a friends list 1231, a upcoming events list 1232 and an groups list 1233. The plurality of navigation tabs 1211-16 includes a home tab 1211 linking to the user's home page (as shown), an events tab 1212 linking to a page for managing the user's events (see FIG. 13), a groups tab 1213 linking to a page for managing the user's groups (see FIG. 14), a find players tab 1214 linking to a page for a user to find new players (see FIG. 15). The home page 1200 also includes a link at the top for a potential user to create an account 1215, a link to the user's personal information page 1216, and a link to the user's full calendar 1260.

In operation, the main windows 1299 of the user's home page 1200 displays notices 1201a-c to the user, as determined by the user's selected setting in the filtering interface 1220. Each notice 1201a-c provides information to the user, which may be posted by another user or a group, and each notice 1201a-c may be associated with the user for one or more of a number of reasons. For example, notices 1201a-c created by the current user, a friend of the user, or a group to which the user belongs, or posted be another user to a group to which the user belongs may all be visible to the user, provided they are filtered to be visible, as explained below. Additionally, each notice 1201a-c contains metadata (not shown) having one or more associated parameters 1229, which enable the notices 1201a-c to be sorted and filtered by the user. Each notice 1201a-c may receive one or more color codes 1209 if the one of the parameters 1229 selected by the user in the filtering interface 1220 is also present in the corresponding notice 1201a-c. As such, each notice 1201a-c may include more parameters 1229in its metadata than indicated by its color codes 1209. Also, each notice 1201a-c may include replies 1202 posted by users or groups in response to the notice 1201a-c.

The filtering interface 1220 includes individual filter categories 1221a-e containing user selectable parameters 1229. The categories 1221a-e and their associated parameters 1229 may be determined by information provided by the user in a profile. Each selected parameter 1229 may have an associated color code 1209. The color codes 1209 may be preselected by the user or automatically generated when a given parameter 1229 is enabled (e.g., the user clicks on the adjacent check box). The filtering interface 1220 also enables a user to save a currently selected set of parameters 1229 as a saved filter 1228 in a separate save filter category 1222. In operation, the user's main window 1299 displays only the notices 1201a-c filtered by the parameters 1229 selected by the user in the filtering interface 1220. As shown, the categories of parameters 1229 may be, for example, groups 1221a, sports 1221b, events 1221c, players 1221d, and skill 1221e. In each category 1221a-e, the user may indicate if the parameters 1229 visible to be selected by the are either (i) associated with the user according to their provided preferences and connections to individual users or groups (e.g., “My Groups”) or (ii) all parameters available to the users (e.g., “All Groups”).

The user's home page 1200 also includes direct links to their upcoming events 1232 and their groups 1233, a list of the user's friends 1240, and an input 1203 for the user to post a notice 1201a-c. Each of the direct link to the user's upcoming events 1232 navigates to a new window or page for that event, which may enable the user to view information about the event, for example, the location, description, and currently attending users, and may also give the user an option to invite other users or change their status (e.g., attending or not attending). Each of the direct link to the user's groups 1233 navigates to a new window or page for that event, which may enable the user to view information about the group, for example, member count, description, upcoming event, and may also give the user an option to leave the group or send a message to the group. The list of the user's friends 1240 may enable the user to view an individual friend's information, for example, their associated sports, groups, events, and friends, and may also enable to the user to send a message to their friend, invite them to an event, or unfriend them.

FIG. 13 is an illustration of an example graphical user interface of a user's events page, viewed from the perspective of the user. The events page 1300 enables the user to quickly see their available events and sort through all available events in a given sport, group, skill level, date range, or location. The events page 1300 also enables a user to create a new event. FIG. 13 shows the events page 1300, as indicated by the selection of a events tab 1212, with the plurality of navigation tabs 1211-16, a main window 1399, a filtering interface 1320, a plurality of event notifications 1341a-c in the main window 1399. The plurality of navigation tabs includes a home tab 1211 linking to the user's home page (see FIG. 12), a events tab 1212 linking to the instant page for viewing the user's events, a groups tab 1213 linking to a page for managing the user's groups (see FIG. 14), a find players tab 1214 linking to a page for a user to find new players (see FIG. 15). The events page 1300 also includes an input 1342 for creating a new event.

In operation, the main windows 1399 of the user's events page 1300 displays events 1341a-c to the user, as determined by the user's selected setting in the filtering interface 1320. Each event 1341a-c provides information to the user regarding the event (e.g., title, sport, time, place, description), and each event 1341a-c may be created by another user or a group and may be associated with the current user for one or more of a number of reasons. For example, events 1341a-c created by the current user, a friend of the user, or a group to which the user belongs, or posted be another user to a group to which the user belongs, may all be visible to the user, provided they are filtered to be visible, as explained above. Additionally, each event 1341a-c contains metadata having one or more parameters 1229, which enable the events 1341a-c to be sorted and filtered by the user according to the parameters 1229. Each event 1341a-c may receive one or more color codes 1209, provided one of the parameters 1229 selected in the filtering interface 1320 is also present in the individual event 1341a-c. Each event 1341a-c may include more parameters than indicated by its color codes 1209.

The filtering interface 1330 includes individual filter categories 1221a,b,e,f,g for selecting parameters 1229 relevant to filtering events 1341a-c in the main window 1399. The categories 1221a,b,e,f,g shown may be determined by information provided by the user in a profile, selected by the user, predetermined by being associated with the events page 1300, or saved in an events-specific filter 1228. As shown, the categories of parameters 1229 on the events page 1300 may be, for example, groups 1221a, sports 1221b, location 1221f, date range 1221g, and skill 1221e.

FIG. 14 is an illustration of an example graphical user interface of a user's groups page, viewed from the perspective of the user. The groups pages 1400 enables a user to quickly sort through their groups and all available groups, in order to join, leave, or see further details about each sorted group. FIG. 14 shows a groups page 1400, as indicated by the selection of a groups tab 1213, the plurality of navigation tabs 1211-16, a main window 1499, a filtering interface 1420, and a plurality of groups 1461a-g in the main window 1499. FIG. 14 also shows a group creation window 1460 in the main window 1499 that enables a user to initiate a process for creating a new group.

In operation, the main windows 1499 of the user's groups page 1400 displays groups 1461a-g to the user, as determined by the user's selected setting in the filtering interface 1420. Each group 1461a-g provides information to the user regarding the group 1461a-g (e.g., title, photo, description) and allows the user to join or leave the group 1461a-g, send a message to the group 1461a-g, or view more details about the groups 1461a-g. Groups 1461a-g, generally, may be created by users and may be visible to the current user for one or more of a number of reasons. For example, public groups 1461a-g, groups to which the user belongs 1461a,b, or private groups to which the user has been invited (not shown), may all be visible to the user, provided they are filtered to be visible, as explained above. Additionally, each group 1461a-g contains metadata having one or more parameters 1229 that enable the groups 1461a-g to be sorted and filtered by the user. Each group 1461a-g may display one or more color codes 1209, provided that one of the parameters 1229 selected in the filtering interface 1420 is also present in the metadata of the group 1461a-g. As such, each group 1461a-g may include more parameters 1299 than indicated by its color codes 1209.

The filtering interface 1420 includes individual filter categories 1221a,b,e,f for selecting parameters 1229 relevant to filtering groups 1461a-g in the main window 1499. The categories 1221a,b,e,f shown may be determined by information provided by the user in a profile, selected by the user, predetermined by being associated with the events page 1400, or saved in a group-specific filter 1428. As shown, the categories 1221a,b,e,f of parameters 1229 on the groups page 1400 may be, for example, groups 1221a, sports 1221b, location 1221f, and skill 1221e.

FIG. 15 is an illustration of an example graphical user interface of a user's find players page, viewed from the perspective of the user. The find players page 1500 enables the user to find individual players based on any of their provided parameters 1229, for example, location or sports played, and also enables a user to sort through their existing friends based on their provided parameters 1229. FIG. 15 shows a find players page 1500, as indicated by the selection of a find players tab 1214, the plurality of navigation tabs 1211-16, a main window 1499, a filtering interface 1520, and a plurality of players 1571a-i in the main window 1599. In operation, the main windows 1599 of the user's find players page 1500 displays players 1571a-i to the user, as determined by the user's selected setting in the filtering interface 1520. Each player 1571a-i displays information to the user regarding the player 1571a-i (e.g., name, photo, location, sports played) and allows the user friend or unfriend the player 1571a-i, send a message to the player 1571a-i, or view the player's 1571a-i profile. Each player 1571a-i contains metadata having one or more parameters 1229, which enable the players 1571a-i to be sorted and filtered by the user in the main window 1599. Each player 1571a-i may display one or more color codes 1209 if one of the parameters 1229 selected in the filtering interface 1520 is also present in the metadata of that player 1571a-i. As such, each player 1571a-g may include more parameters 1229 than indicated by its color codes 1209.

The filtering interface 1520 includes individual filter categories 1221b,d,e,f for selecting parameters 1229 relevant to filtering players 1571a-i in the main window 1599. The categories 1221b,d,e,f shown may be determined by information provided by the user in a profile, selected by the user, predetermined by being associated with the find players page 1500, or saved in a group-specific filter 1428. As shown, the categories 1221b,d,e,f of parameters 1229 on the find players page 1300 may be, for example, sports 1221b, players 1221d, location 1221f, and skill 1221e.

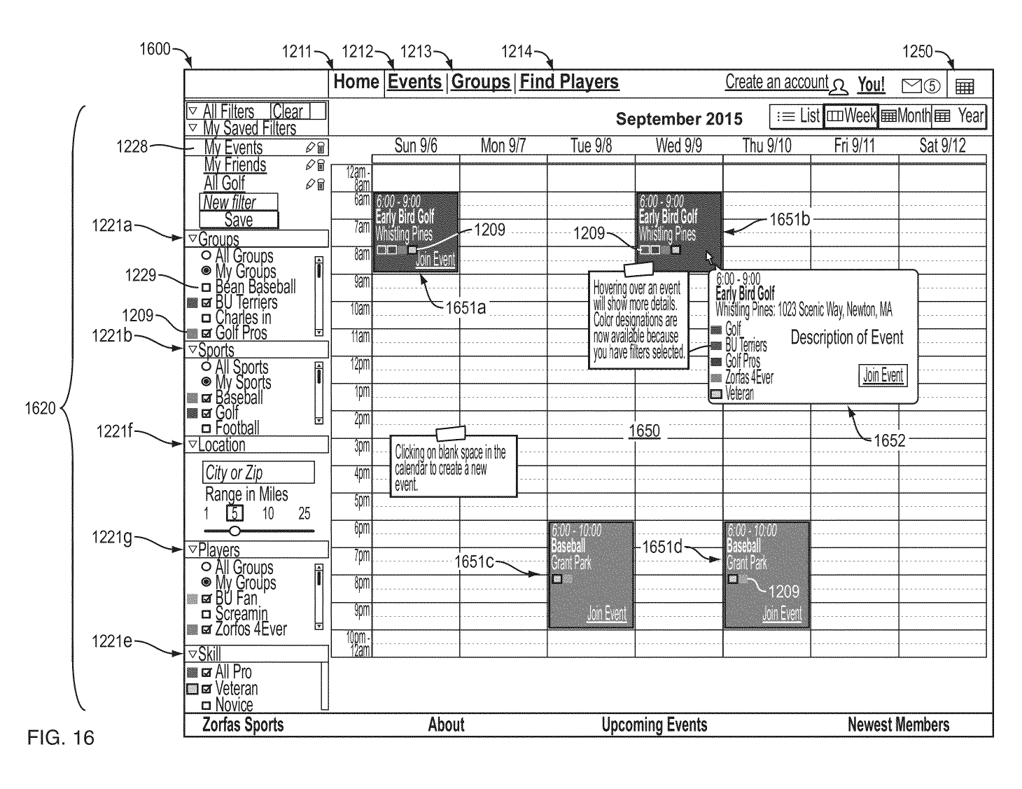

FIG. 16 is an illustration of an example graphical user interface of a user's calendar, viewed from the perspective of the user. The calendar page 1600 enables the user to view upcoming events and easily sort them by their associated parameter 1229. The user's calendar page also enables the user to join or leave an event. FIG. 16 shows a calendar page 1600, as indicated by the selection of the calendar icon 1250, the plurality of navigation tabs 1211-16, a main window 1499, a filtering interface 1620, and a plurality of events 1651a-d. In operation, the calendar 1650 of the user's calendar page 1600 displays events 1651a-d to the user, as determined by the user's selected setting in the filtering interface 1620. Each event 1651a-d displays information to the user regarding the event 1651a-d (e.g., time, title, location, sports played) and allows the user to join or leave each event 1651a-d. As described above with respect to FIG. 12, each event 1651a-d contains metadata having one or more parameters 1229, which enable the events 1651a-d to be sorted and filtered by the user in the calendar 1650. Each event 1651a-d may display one or more color codes 1209 if one of the parameters 1229 selected in the filtering interface 1620 is also present in the metadata of that event 1651a-d. As such, each events 1651a-d may include more parameters 1229 than indicated by its color codes 1209. Additionally, a pop-up window 1652 may be present, for example, if the user places their cursor over an individual event 1651b, showing a description of the event 1651b and the name of and color of each parameters 1229 both present in the metadata of the event1651b and selected in the filtering interface 1620.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for scheduling an athletic event between a plurality of users on a social-network-web site-service, the apparatus comprising:
a processor;
a computer means coupled to processor and configured to:
provide to a user a graphical user interface, said graphical user interface comprising an interactive calendar, a communication window, and a user-customized browser tool;
receive a user-created base profile, wherein the user-created base profile comprises information about a user and a plurality of individual sport profiles, each individual sport profile comprising a set of criteria, the set of criteria being related to an identified sport on one of the plurality of individual sport profiles and comprising parameters relating to said user's preferences with respect to the identified sport;
receive event parameters which enable scheduling of the identified sport between at least two of the plurality of users, the scheduling of the identified sport includes arranging an appointment between the at least two of the plurality of users, and the event parameters including a common identified sport selected by the at least two of the plurality of users, and a venue,
wherein arranging the appointment between at least two of the plurality of users includes providing a calendar indicating availability for each user to participate in the common identified sport selected by the at least two of the plurality of users; and
arrange the athletic event between the plurality of users, wherein arranging includes communicating to the plurality of users the common identified sport availability of each user.

2. The apparatus of claim 1, wherein the user is one of a single person, a group of people, and a business organization.

3. The apparatus of claim 1, wherein the computer is further configured to display advertisements from one or more users in the graphical user interface.

4. The apparatus of claim 3, wherein the business organization is a sports club, and the computer means are further configured to:
identify, by the social network system, a plurality of club members from the plurality of users on the social-network-website-service; and
aggregate, by the social network system, the set of criteria from each individual sport profile of the plurality of club members to create a set of club member data.

5. The apparatus of claim 1, wherein user's preferences with respect to the identified sport comprises skill level, location, and availability.

6. The apparatus of claim 1, wherein user's preferences with respect to the identified sport comprises keywords input by the user.

7. The apparatus of claim 1, wherein the computer means enables the user to filter the plurality of users using any of the parameters of the user's set of criteria related to an identified sport

8. The apparatus of claim 1, wherein the computer means enables the user to filter the plurality of users using the information about each of plurality of users.

9. The apparatus of claim 1, wherein each parameter relating to said user's preferences with respect to the identified sport is assigned a color, and wherein each assigned color is used to represent similar preferences of the plurality of users and present a visual correspondence to the user in the graphical user interface between the user's preferences and one or more preferences each of the plurality of users.

10. The apparatus of claim 1, wherein the criteria is a user-specified ranking of skill in a sport.

11. The apparatus of claim 1, wherein the computer means are further configured to receive instructions from a user to search for other users using a user-defined set of criteria, and providing to the user a list of other users which match the user-defined set of criteria.

12. The apparatus of claim 11, further comprising receiving, by the social network system, a request for a list of users that match with the user-defined set of criteria.

13. The apparatus of claim 1, wherein the calendar indicating sport-specific availability is organized by color, wherein one color correlates to one sport.

14. The apparatus of claim 1, wherein the computer means are further configured to receive information from one of the plurality of users regarding a rating of another user.

15. The apparatus of claim 1, wherein the computer means are further configured to arrange the athletic event further comprises making a reservation at a selected venue.

16. The apparatus of claim 1, wherein the communication window and the interactive calendar for the user appear consistently on substantially all base profiles and sport profiles that the user views.

17. The apparatus of claim 1, wherein the communication window receives and sends messages from one or more of the plurality of users.

18. The apparatus of claim 1, wherein the communication window is organized by message color, the message color selected by the user to indicate one or more of the following: a sport, a venue, another user, and any of the parameters of the user's set of criteria related to an identified sport.

19. An computer program product for scheduling an athletic event between a plurality of users on a social-network-website-service, the computer program product comprising:
in a digital processor, a computer readable medium embodying program instructions, the program instructions, when executed by the digital processor causes a social network system to:
provide to a user a graphical user interface, said graphical user interface comprising an interactive calendar, a communication window, and a user-customized browser tool;
receive a user-created base profile, wherein the user-created base profile comprises information about a user and a plurality of individual sport profiles, each individual sport profile comprising a set of criteria,
wherein the set of criteria is related to an identified sport on one of the plurality of individual sport profiles and comprises parameters relating to said user's preferences with respect to the identified sport;
receive event parameters which enable scheduling of the identified sport between at least two of the plurality of users, the scheduling of the identified sport includes arranging an appointment between the at least two of the plurality of users,
wherein event parameters include a common identified sport selected by the at least two of the plurality of users, and a venue,
wherein arranging the appointment between at least two of the plurality of users includes providing a calendar indicating availability for each user to participate in the common identified sport selected by the at least two of the plurality of users;
arrange the athletic event between the plurality of users, wherein arranging includes communicating to the plurality of users the common identified sport availability of each user.

20. A method of scheduling an athletic event between a plurality of users on a social-network-website-service, the method comprising:
providing to a user, by a social network system, a graphical user interface, the graphical user interface comprising an interactive calendar, a communication window, and a user-customized browser tool;
receiving, by a social network system, a user-created base profile having information about a user and a plurality of individual sport profiles, each individual sport profile comprising a set of criteria, and the set of criteria being related to an identified sport on one of the plurality of individual sport profiles and comprising parameters relating to said user's preferences with respect to the identified sport;
receiving, by the social network system, event parameters which enable scheduling of the identified sport between at least two of the plurality of users, the scheduling of the identified sport includes arranging an appointment between the at least two of the plurality of users, and the event parameters having a common identified sport selected by the at least two of the plurality of users and a venue,
wherein arranging the appointment between at least two of the plurality of users includes indicating availability for each user to participate in the common identified sport selected by the at least two of the plurality of users via the interactive calendar; and
arranging, by the social network system, the athletic event between the plurality of users, wherein arranging includes communicating to the plurality of users the common identified sport availability of each user.
